(19) United States
(12) Patent Application Publication
(10) Pub. No.: US 2017/0089504 A1
(43) Pub. Date: Mar. 30, 2017

(54) FIBERGLASS INSULATION PRODUCT

(71) Applicant: Owens Corning Intellectual Capital, LLC, Toledo, OH (US)

(72) Inventors: Kevin Herreman, Newark, OH (US); Harry Alter, Granville, OH (US); Larry Grant, Westerville, OH (US); Javier Cuadrado, New Albany, OH (US)

(21) Appl. No.: 15/279,967

(22) Filed: Sep. 29, 2016

Related U.S. Application Data
(60) Provisional application No. 62/234,225, filed on Sep. 29, 2015.

(51) Int. Cl. F16L 59/02; C03C 25/26

(52) U.S. Cl. CPC F16L 59/028; C03C 25/26

(57) ABSTRACT

A glass fiber thermal insulation product, comprising a collection of non-woven glass fibers held together by a cured binder, wherein the insulation product after curing has a density, when uncompressed, in the range of about 1.5 pcf to about 7.0 pcf and wherein the quantity of binder is less than 7% by weight.

### CROSS REFERENCE TO RELATED APPLICATION

This application claims the benefit of U.S. Provisional Application No. 62/234,225, entitled “FIBERGLASS INSULATION PRODUCT” filed Sep. 29, 2015, which is herein incorporated by reference in its entirety.

### FIELD OF THE INVENTION

The present application generally relates to fiberglass insulation products.

### BACKGROUND OF THE INVENTION

The term “fibrous insulation product” is general and encompasses a variety of compositions, articles of manufacture, and manufacturing processes. Fibrous insulation products may be characterized by many different properties, such as for example, density. Low density flexible insulation batts and blankets typically have densities between about 0.5 pounds/cubic foot (“pcf”) and about 2 pcf, and are often used for residential insulation in walls, attics and basements. Fibrous insulation products also include higher density products having densities from about 7 pcf to about 10 pcf, such as boards and panels or formed products. Higher density insulation products are often used in industrial and/or commercial applications, including but not limited to metal building wall and ceiling insulation, pipe or tank insulation, insulative ceiling and wall panels, duct boards, etc.

### SUMMARY OF THE INVENTION

A fibrous thermal insulation product, comprising a collection of non-woven glass fibers held together by a cured binder, wherein the cured product has an uncompressed density in the range of about 1.5 pcf to about 7 pcf and wherein the quantity of binder is less than 7% by weight.

### BRIEF DESCRIPTION OF THE DRAWINGS

Features and advantages of the present invention will become apparent to those of ordinary skill in the art to which the invention pertains from a reading of the following description together with the accompanying drawings, in which:

FIG. 1 is a sectional view of an exemplary embodiment of a fibrous insulation product;

and

FIG. 2 is a partially sectioned side elevation view of an exemplary embodiment of an apparatus for manufacturing fibrous insulation products.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. Unless otherwise indicated, all numbers expressing ranges of magnitudes, such as quantities of ingredients, properties such as density, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

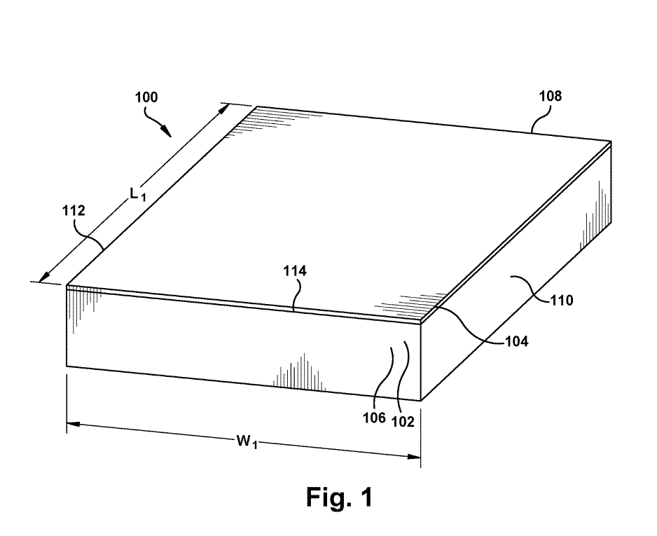

FIG. 1 illustrates an exemplary embodiment of a fibrous insulation product 100. The fibrous insulation product 100 may be configured in a variety of ways. In the illustrated embodiment, the fibrous insulation product 100 is a generally box-shaped fiberglass insulation batt. In other embodiments, however, the insulation product can be any suitable shape or size, such as, for example a rolled product. The fibrous insulation product 100 includes an insulation layer 102 comprising nonwoven glass fibers and a binder to adhere the glass fibers together. Optionally, the fibrous insulation product 100 may also include a facing 104 attached or otherwise adhered to the insulation layer 102. The fibrous insulation product 100 includes a first side edge 106, second edge 108 spaced apart from and opposite the first edge, a third edge 110 extending between the first edge and the second edge, and a fourth edge 112 spaced apart from and opposite the third edge and extending between the first edge and the second edge. The fibrous insulation product 100 also includes a first face 114 connecting the side edges 106-112 and a second face parallel to, or generally parallel to, and opposite the first face and connecting the side edges 106-112. The fibrous insulation product 100 has a length L1, a thickness T1, and a width W1.

The facing 104 may be disposed on the first face 114 of the fibrous insulation product 102. The facing 104 may take a wide variety of different forms. The facing 104 can be a single piece or multiple different pieces or sheets of material and may include a single layer or several layers of material. In the exemplary embodiment of FIG. 1, the facing 104 is a single piece of material that is disposed on the first face surface 114 such that the facing substantially covers the entire the first face surface.

The facing 104 may be made from a variety of different materials. Any material suitable for use with a fibrous insulation product may be used. For example, the facing 104 may comprise nonwoven fiberglass and polymeric media, woven fiberglass and polymeric media, sheathing materials, such as sheathing films made from polymeric materials, scrim, cloth, fabric, and fiberglass reinforced kraft paper (FRK).

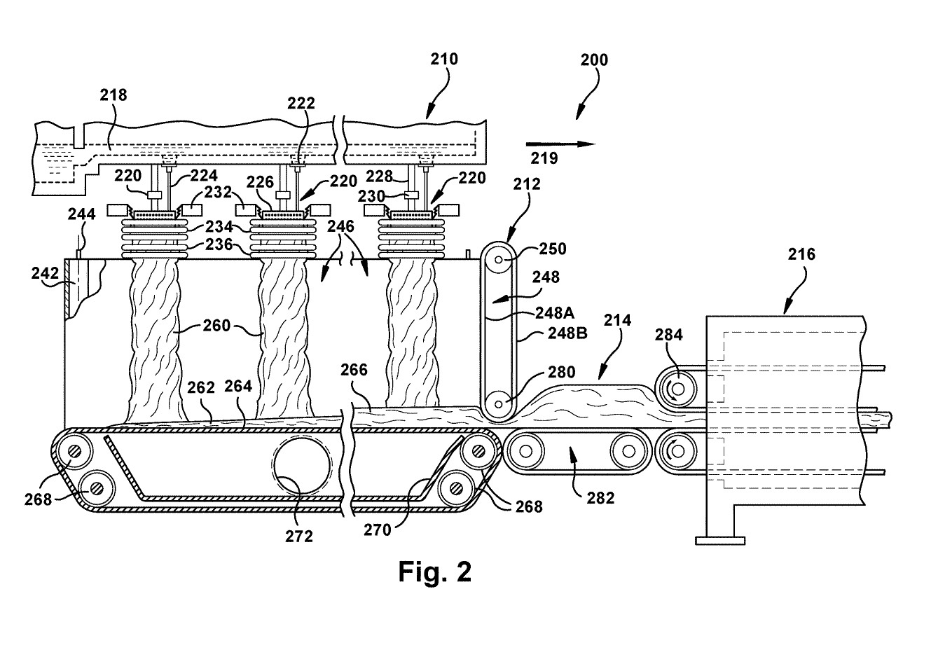

FIG. 2 illustrates an apparatus 200 for manufacturing fibrous insulation products including a forehearth 210, forming hood component or section 212, a ramp conveyor section 214 and a curing oven 216. Molten glass from a furnace (not shown) is led through a flow path or channel 218 to a plurality of fiberizing stations or units 220 that are arranged serially in a machine direction, as indicated by arrow 219 in FIG. 1. At each fiberizing station, bushings or holes 222 in the flow channel 218 allow a stream of molten glass 224 to flow into a spinner 226, which may optionally be heated by a burner (not shown). Although spinners 226 are shown as the fiberizing unit in the present embodiments, it will be understood that other types of fiberizing units may be used to form fibrous insulation product. Fiberizing spinners 226 are rotated about a shaft 228 by motor 230 at high speeds such that the molten glass is forced to pass through tiny orifices in the circumferential sidewall of the spinners 226 to form primary fibers. Blowers 232 direct a gas stream, typically air, in a substantially downward direction to impinge the fibers, deflecting them downward and attenuating them into secondary fibers having an average diameter in the range of from about 1 μm to about 25 μm. In some embodiments, the glass fiber has an average diameter in the range of from about 2 μm to about 10 μm or from about 3 μm to about 6 μm. The fibers form a veil 260 that is forced downwardly and may be distributed in a cross-machine direction by mechanical or pneumatic “lappers” (or other means, not shown), eventually forming a fibrous layer 262 on a porous conveyor 264. The layer 262 gains mass (and typically thickness) with the deposition of additional fiber from the serial fiberizing units, thus becoming a fibrous ‘pack’ as it travels in the machine direction 219 through the forming section 212.

One or more cooling rings 234 spray coolant liquid, such as water, on veil 260 to cool the forming area and, in particular, the fibers within the veil. Other coolant sprayer configurations are possible, of course, but rings have the advantage of delivering coolant liquid to fibers throughout the veil 260 from a multitude of directions and angles. For some insulation products, a binder dispensing system includes binder sprayers 236 to spray binder onto the veil 260. Illustrative coolant spray rings and binder spray rings are disclosed in US Patent Publication 2008-0156041 A1, to Cooper, incorporated herein by reference. Each fiberizing unit 220 thus comprises a spinner 226, a blower 232, one or more cooling liquid sprayers 234, and one or more binder sprayers 236. FIG. 1 depicts three such fiberizing units 220, but any number may be used. For typical insulation products, from two to about 15 units, typically 3 to about 12 units, may be used in one forming hood component for one line.

The porous conveyor 264 contains numerous small openings allowing the air flow to pass through while links essentially filter the fibers and support the growing fibrous pack. A suction box 270 connected via duct 272 to fans or blowers (not shown) are additional production components located below the conveyor 264 to create a negative pressure and remove air injected into the forming section 212. As the conveyor 264 rotates around its rollers 268, the uncured pack 266 exits the forming section 212 under exit roller 280, where the absence of downwardly directed airflow and negative pressure (optionally aided by a pack lift fan, not shown) allows the pack to regain its natural, uncompressed height or thickness. A subsequent supporting conveyor or “ramp” 282 leads the uncured fibrous pack toward the curing oven 216 and between another set of porous compression conveyors 284 for shaping the pack to a desired thickness for curing in the oven 216. Upon exit from the oven 216, the cured pack or “blanket” (not shown) is conveyed downstream for cutting and packaging steps. For some products, the blanket is split longitudinally into multiple lanes and then chopped into shorter segments known as “batts.” These may be bundled or rolled for packaging.

The forming hood section or component 212 is further defined by at least one hood wall 240, and usually two such hood walls on opposing sides of the conveyor 264 to define a forming chamber or area 246. For clarity in FIG. 1, the hood wall 240 is depicted on only one side (behind conveyor chain 264), and a portion of the wall 240 on the left end is removed to reveal a roller 242. Typically, each of the hood walls 240 takes the form of a loop or belt having an inward-directed flight and an outside flight. The inward-directed flight defines a sidewall of the forming area 246 and moves through the forming area by rotating about vertical rollers 242; while the outside flight closes the loop outside of the forming area 246. End walls 248 (one shown at the right end of the forming area 246) of similar belt construction may further enclose the forming area 246 with an inward facing flight 248A and an outward return flight 248B. As shown in FIG. 1, however, the rollers 250, 280 for the end wall 248 may be oriented transversely compared to the rollers 242. A similar end wall (not shown) may be present on the left end of the forming area 246. The terms “forming hoodwall”, “hoodwall” and “hood wall” may be used interchangeably herein to refer to the wall(s) that define and enclose the forming area 246.

In the context of the fibrous insulation product 100, “binders” refer to organic agents or chemicals, often polymeric resins, used to adhere the glass fibers to one another in a three-dimensional structure. Binders are typically delivered as an aqueous dispersion of the binder chemical, which may or may not be soluble in water. “Binder dispersions” thus refer to mixtures of binder chemicals in a medium or vehicle.

A wide variety of binders, or combination of binders, may be used with the glass fibers of the present invention. For example, binders fall into two broad, mutually exclusive classes: thermoplastic and thermosetting. Both thermoplastic and thermosetting binders may be used with the invention. A thermoplastic material may be repeatedly heated to a softened or molten state and will return to its former state upon cooling. In other words, heating may cause a reversible change in the physical state of a thermoplastic material (e.g. from solid to liquid) but it does not undergo any irreversible chemical reaction. Exemplary thermoplastic polymers suitable for use in the fibrous insulation product 100 include, but are not limited to, polyvinyls, polyethylene terephthalate (PET), polypropylene or polyphenylene sulfide (PPS), nylon, polycarbonates, polystyrene, polyamides, polyolefins, and certain copolymers of polyacrylates.

In contrast, the term thermosetting polymer refers to a range of systems which exist initially as liquids but which, on heating, undergo a reaction to form a solid, highly crosslinked matrix. Thus, thermosetting compounds comprise reactant systems—often pairs of reactants—that irreversibly crosslink upon heating. When cooled, they do not regain their former liquid state but remain irreversibly crosslinked.

The reactants useful as thermosetting compounds generally have one or more of several reactive functional groups: e.g. amine, amide, carboxyl or hydroxyl. As used herein, “thermoset compound” (and its derivative clauses like “thermosetting compound,” “thermosetting binder” or “thermoset binder”) refers to at least one of such reactants, it being understood that two or more may be necessary to form the crosslinking system characteristic of thermosetting compounds. In addition to the principle reactants of the thermosetting compounds, there may be catalysts, process aids, and other additives.

Phenolic/formaldehyde binders are a known thermosetting binder system. The present invention encompasses both traditional phenolic-formaldehyde binders, as well as the more recent formaldehyde-free binders. Formaldehyde-free, thermosetting binder systems may include polyacrylic acid and polyol polymers. An example is the polyacrylic acid/polyol/polyacid acid binder system described in U.S. Pat. Nos. 6,884,849 and 6,699,945 to Chen, et al., the entire contents of which are expressly incorporated herein by reference. A second category of formaldehyde-free, thermosetting binders are referred to as “bio-based” or “natural” binders. “Bio-based binder” and “natural binder” are used interchangeably herein to refer to binders made from nutrient compounds, such as carbohydrates, proteins or fats, which have much reactive functionality. Because they are made from nutrient compounds they are very environmentally friendly. Bio-based binders are described in more detail in U.S. Patent Publication 2011/0086567, to Hawkins et al., filed Oct. 8, 2010, the entire contents of which are expressly incorporated herein by reference. In one exemplary embodiment, the binder includes Owens-Corning's EcoTouch™ or EcoPure™ binders.

In the exemplary embodiment, the fibrous insulation product 100 may include less than 7% by weight of a binder and have an original density in the range of from about 1.5 pcf to about 7.0 pcf. In the context of the present disclosure, “original density” refers to the density of the fibrous product after the thermoplastic or thermoset binder has been cured and the cured product being in a free state (i.e. not compressed or stretched)

In one exemplary embodiment, the fibrous insulation product 100 includes a collection of unwoven glass fibers and less than 7% by weight of a formaldehyde-free binder. In some exemplary embodiments, the cured fibrous insulation product 100 has in the range of from about 1% by weight to about 7% by weight of a binder. In some exemplary embodiments, the cured fibrous insulation product 100 has less than 3% by weight of a binder, or less than 4% by weight of a binder. In some embodiments, the density of the fibrous insulation product, after cured and uncompressed, is in the range of about 2 pcf to about 5 pcf, in the range of about 2 pcf to about 3.5 pcf, or in the range of about 2.2 pcf to about 2.8 pcf. Any of the disclosed ranges of binder content can be used with any of the disclosed ranges of fibrous insulation product density.

Noise Reduction Coefficient (NRC) is the average ratio of sound energy absorbed incident to the surface of a porous material to a similarly sized, ideally absorbent system that would not reflect any sound back into the room at 250 Hz, 500 Hz, 1000 Hz, and 2000 Hz octave bands. NRC can be thought of as a rule of thumb percentage of sound that is absorbed (1=100%). NRC values, however, may be higher than one (1), but that is typically representative of diffraction effects from the perimeter edge of the test sample. The material coefficient is the arithmetic average, rounded to the nearest multiple of 0.05, of the absorption coefficients for the specific material and mounting condition determined at the one octave band center frequencies of 250, 500, 1000 and 2000 Hz. In some embodiments, the NRC of the fibrous insulation product 100 is about 1.00 or greater, or about 1.15 or greater, or about 1.20 or greater. In some embodiments, the NRC of the fibrous insulation product 100 is in the range of about 1.00 to about 1.35, or about 1.15 to about 1.35. One exemplary embodiment of the fibrous insulation product 100, having a thickness T1 of about 3.5 inches, and an original density of 2.4 pcf, has a measured NRC of 1.15. In another exemplary embodiment of the fibrous insulation product 100, having a thickness T1 of about 3.5 inches, and an original density of 1.7 pcf, has a measured NRC of 1.20.

Depending on the specific material characteristics of various exemplary embodiments, the fibrous insulation product 100 may also provide superior low frequency sound absorption below 250 Hertz. For some exemplary embodiments, Table 2 shows the low frequency sound absorption coefficients (LFSA) at various nominal thickness T1 of the product by ⅓ octaves as determined by ASTM C423-Standard Test Method for Sound Absorption and Sound Absorption Coefficients by the Reverberation Room Method.

TABLE 2

| | LFSA at T1 | LFSA at T1 | LFSA at T1 | LFSA at T1 of |
|---|---|---|---|---|
| Frequency | of 1″ to 3.5″ | of 3.5″ to 6.5″ | of 6.5″ to 12″ | >12″ |
| 40 Hz | 0.05 to 0.12 | 0.10 to 0.20 | 0.20 to 0.30 | >0.30 |
| 50 Hz | 0.10 to 0.16 | 0.15-0.30 | 0.30 to 0.45 | >0.45 |
| 63 Hz | 0.10 to 0.22 | 0.20-0.35 | 0.35 to 0.55 | >0.55 |
| 80 Hz | 0.20 to 0.35 | 0.34-0.55 | 0.55 to 0.85 | >0.85 |
| 100 Hz | 0.20 to 0.35 | 0.25-0.50 | 0.50 to 0.90 | >0.90 |
| 125 Hz | 0.30 to 0.65 | 0.55 to 0.80 | 0.80 to ≧1.00 | ≧1.00 |
| 160 Hz | 0.60 to ≧1.00 | 0.90 to ≧1.00 | ≧1.00 | ≧1.00 |
| 200 Hz | 0.60 to ≧1.00 | ≧1.00 | ≧1.00 | ≧1.00 |

Air flow resistivity R is a parameter used to describe the acoustical behavior of porous materials. For fiberglass insulation, air flow resistivity is a function of the specific gravity of the glass, the amount of binder in the product (% by weight), the product density, and the fiber size. In some embodiments, the air flow resistivity R of the fibrous insulation product 100 is in the range of about 4,000 to about 40,000 mks Ralys/m. In some embodiments the air flow resistivity R of the fibrous insulation product 100 is greater than 15,000 mks Ralys/m, or greater than 20,000 mks Ralys/m, or greater than 30,000 mks Ralys/m, or greater than 35,000 mks Ralys/m. One exemplary embodiment of the fibrous insulation product 100, having a thickness T1 of about 3.5 inches, and an original density of 2.4 pcf, has an air flow resistivity R of from about 37,000 mks Ralys/m to about 39,000 mks Ralys/m.

In some exemplary embodiments, a facing (e.g., the facing 104) can be used in the fibrous insulation product 100 to further enhance the acoustic performance of the fibrous insulation product.

Fire rating for building materials, such as insulation, are based on ASTM E-119 tests (Standard Test Method for Fire Tests of Building Construction and Materials). In some exemplary embodiments of the fibrous insulation product 100, having a thickness T1 of about 3.5 inches in a wall assembly with Type X Gypsum with metal studs, having original density of about 1.7 pcf or greater in the wall assembly, may achieve about 100 minutes or more below a 250 deg. F change in temperature during the ASTM E-119 ( 1/10 th scale) fire test. For example, in one exemplary embodiment of the fibrous insulation product 100, having a thickness T1 of about 3.5 inches, and an original density of 2.4 pcf in a wall assembly with Type X Gypsum with metal studs, achieved 105 minutes below a 250 deg. F change in temperature during the ASTM E-119 ( 1/10th scale) fire test. Further, in another exemplary embodiment of the fibrous insulation product 100, having a thickness T1 of about 3.5 inches, and an original density of 2.86 pcf, in a wall assembly with Type X Gypsum with metal studs, achieved 126 minutes below a 250 deg. F change in temperature during the ASTM E-119 ( 1/10th scale) fire test.

In some exemplary embodiments, a facing (e.g., the facing 104) can be used in the fibrous insulation product 100 to further enhance the fire resistance of the fibrous insulation product.

As shown in Table 3, some embodiments of the fibrous insulation product 100 may have the following properties:

TABLE 3

| Property | Units | Value |
|---|---|---|
| Recovered Thickness | inches | 1-12 |
| Batt Length | inches | 45-105 |
| Batt Width | inches | 11-48 |
| Stiffness | degrees | 5-50 |
| Square Foot Weight | lbs./ft.² | 0.36-1.40 |
| (from stiffness) | | |
| Dust | grams | 0.002-0.015 |
| Parting Strength | lbs./g | 0.6-1.5 |
| Fiber Diameter | Microns (3.93 ht = | 10 ht to 30 ht |
| | microns) | |
| Shot Content | % | 0.00-10.00 |
| Mold Resistance | | does not promote mold |
| | | growth |

The fiberglass insulation materials of the present invention may have any combination or sub-combination of the properties disclosed and the ranges for those properties disclosed herein.

While the present invention has been illustrated by the description of embodiments thereof, it is not the intention of the applicant to restrict or in any way limit the scope of the appended claims to such detail. Additional advantages and modifications will readily appear to those skilled in the art. While the fibrous insulation product has been illustrated herein as a flexible batt or blanket, other configurations and geometries can be used. Further, the fibrous insulation product may be used in a variety of ways and is not limited to any specific application. Therefore, the invention, in its broader aspects, is not limited to the specific details, the representative apparatus, and illustrative examples shown and described. Accordingly, departures can be made from such details without departing from the spirit or scope of the applicant's general inventive concept.

1. A glass fiber thermal insulation product, comprising a collection of non-woven glass fibers held together by a cured binder, wherein the insulation product after curing has a density, when uncompressed, in the range of about 1.5 pcf to about 7.0 pcf and wherein the quantity of binder is less than 7% by weight.

2. The glass fiber thermal insulation product of claim 1 wherein the uncompressed density is in the range of about 2 pcf to about 5 pcf.

3. The glass fiber thermal insulation product of claim 1 wherein the uncompressed density is in the range of about 2 pcf to about 2.5 pcf.

4. The glass fiber thermal insulation product of claim 1 wherein the quantity of binder is less than 4% by weight.

5. The glass fiber thermal insulation product of claim 1 wherein the binder a formaldehyde-free, thermosetting binder.

6. The glass fiber thermal insulation product of claim 1 wherein the product has an air flow resistivity of greater than 15,000 mks Ralys/m.

7. The glass fiber thermal insulation product of claim 1 wherein the product has an air flow resistivity of greater than 35,000 mks Ralys/m.

8. The glass fiber thermal insulation product of claim 1 wherein the product has an noise reduction coefficient of about 1.00 to about 1.35.

9. The glass fiber thermal insulation product of claim 1 wherein the product has an noise reduction coefficient of greater than 1.15.

10. The glass fiber thermal insulation product of claim 1 wherein the product achieved greater than 100 minutes below a 250 deg. F change in temperature during the ASTM E-119 ( 1/10th scale) fire test.

11. A process for the preparation of a cured glass fiber product comprising the steps of:
forming a plurality of glass fibers;
applying a heat curable binder composition to the glass fibers;
consolidating the fibers and heat curable binder into a loosely packed mass; and
curing the loosely packed mass to form a glass fiber product;
wherein the binder composition in the cured product is 7% by weight and the original density of the cured product is in the range of about 1.5 pcf to about 7.0 pcf.

12. A process for the preparation of a cured glass fiber product according to claim 11 wherein the quantity of binder is less than 6% by weight.

13. A process for the preparation of a cured glass fiber product according to claim 11 wherein the quantity of binder is less than 3% by weight.

14. A process for the preparation of a cured glass fiber product according to claim 11 wherein the density is in the range of about 2 pcf to about 5 pcf.

15. A process for the preparation of a cured glass fiber product according to claim 11 wherein the density is in the range of about 2 pcf to about 2.5 pcf.

16. A process for the preparation of a cured glass fiber product according to claim 11 wherein the product has an air flow resistivity of greater than 35,000 mks Ralys/m

17. A process for the preparation of a cured glass fiber product according to claim 11 wherein the product has an noise reduction coefficient of greater than 1.15.
